(19) United States
(12) Patent Application Publication
(10) Pub. No.: US 2007/0257496 A1
(43) Pub. Date: Nov. 8, 2007

(54) Latch assembly

(76) Inventors: Nigel Victor Spurr, Solihull (GB); Denis Cavallucci, Otterswiller (FR); Gurbinder Singh Kalsi, West Midlands (GB); Chris Rhodes, Orleans (FR); Sylvain Remi Chonavel, Le Pecq (FR); David Peatey, Solihull (GB); Paul Moore, Kings Norton (GB); Robert F. Tolley, Staffordshire (GB); Jean-Vincent Olivier, Villegusien (FR); Robert James Clawley, Staffordshire (GB)

Correspondence Address: CARLSON, GASKEY & OLDS, P.C., 400 WEST MAPLE ROAD, SUITE 350, BIRMINGHAM, MI, 48009, US

(21) Appl. No.: 11/707,659

(22) Filed: Feb. 16, 2007

(30) Foreign Application Priority Data
Feb. 17, 2006 (GB) 0603242.9

(51) Int. Cl. E05C 5/02

(52) U.S. Cl. 292/57

(57) ABSTRACT

A latch assembly includes a chassis and a rotatable claw-type latch bolt moveably mounted on the chassis. The latch bolt has a closed position for retaining a striker and an open position for releasing the striker. The latch bolt is provided with a latch abutment remote from a center of rotation. The latch assembly further includes a pawl rotatable about a pawl axis and having an engaged position for holding the latch bolt in the closed position and a disengaged position that allows the latch bolt to move to the open position. The latch assembly includes an eccentric arrangement defining a first axis and the pawl axis remote from the first axis. The latch assembly also includes a reset lever rotatably fixed to the eccentric arrangement for mutual rotation with the eccentric arrangement about the first axis. The latch assembly includes a biasing lever configured to transmit a biasing force to the reset lever at a position remote from the first axis and to the latch bolt via the latch abutment. The latch assembly includes a biasing device arranged to apply the biasing force to the biasing lever. The latch assembly is configured such that when the pawl retains the latch bolt in the closed position, the biasing lever applies a force to the reset lever to promote disengagement of the pawl, and such that when the pawl is disengaged, the biasing lever promotes the rotation of the latch bolt into the open position.

### REFERENCE TO RELATED APPLICATIONS

This application claims priority to United Kingdom Patent Application GB 0603242.9 filed on Feb. 17, 2006.

### BACKGROUND OF THE INVENTION

The present invention relates generally to latch assemblies, and in particular to latch assemblies for use with car doors and car boots (trunks).

Latch assemblies are known to releasably secure car doors in a closed position. Operation of an inside door handle or an outside door handle will release the latch, allowing the door to open. Subsequent closure of the door will automatically relatch the latch.

To ensure that rain does not enter the vehicle, weather seals are provided around a peripheral edge of the doors which close against an aperture in a vehicle body in which the door sits. In addition to providing protection from the rain, the weather seals also reduce the wind noise. The ongoing requirement for improved vehicle occupant comfort requires minimization of wind noise, which in turn requires the weather seals to be clamped tighter by the door. The door clamps the seals by virtue of the door latch. Accordingly, there is a tendency for a seal load exerted on the door latch to be increased to meet the required increased occupancy comfort levels. Because the seal force on the latch is increased, the forces required to release the latch are correspondingly increased.

U.S. Pat. No. 3,386,761 shows a vehicle door mounted latch having a rotatable claw which releasably retains a vehicle body mounted striker to hold a door in a closed position. The rotatable claw is held in the closed position by a first pawl, and the first pawl is held in the closed position by a second pawl. The second pawl can be moved to a release position by an electric actuator, which in turn frees the first pawl, which allows the rotatable claw to rotate to an open position. The system is arranged such that once the second pawl has disengaged the first pawl, the first pawl is driven to a release position by the seal load acting on the rotatable claw.

US2004/0227358 shows a rotatable claw held in a closed position by a rotatable lever and a link. The rotatable lever can in turn be held in position by a pawl. Disengaging the pawl from the rotatable lever allows the rotatable lever, the link and the pawl to move to an open position. One end of the link remains in permanent engagement with the rotatable claw. The system is arranged such that once the pawl has disengaged from the rotatable lever, the rotatable lever and the link are driven to the open position by the seal load acting on the rotatable claw.

EP0978609 shows a rotatable claw that can be held in a closed position by a pawl. The pawl is mounted on a cam. During an initial part of opening of a latch, the cam rotates relative to the pawl, thereby initially slightly increasing and then significantly reducing a seal load. During a final part of opening of the latch, the cam and the pawl rotate in unison, thereby disengaging a pawl tooth from a claw tooth. However, the arrangement is such that the cam must be driven by a motor to release the latch. In particular, in the closed position, the particular configuration of a cam axis, a pawl pivot axis and a pawl tooth is such that latch will remain shut. Thus, in the closed position, the pawl pivot axis (28 of EP0978609) lies just to one side of a line (31 of EP0978609) drawn between the cam axis and a point where the pawl tooth contacts the rotatable claw. Significantly, the pawl pivot axis must move towards this line for the latch to be opened. In other words, the pawl is at an over-center position such that the cam is driven in a closing direction when the latch has been closed.

DE10214691 and U.S. Pat. No. 5,188,406 are similarly in an overcenter position when in the closed position.

Thus, EP0978609, DE10214691 and U.S. Pat. No. 5,188,406 all show latches in which the component in direct contact with the claw (the pawl) is in a stable position. U.S. Pat. No. 3,386,761 and US2004/0227358 both show latches wherein the component in direct contact with the claw is in an unstable position and therefore requires a further component (the second pawl in U.S. Pat. No. 3,386,761 and the pawl in US2004/0227358) to hold the component that directly engages the claw in the unstable position.

### SUMMARY OF THE INVENTION

An object of the present invention is to provide a compact latch arrangement. Another object of the present invention is to provide a reduced force release latch that is reliable in operation.

Thus, the present invention provides a latch assembly including a chassis and a rotatable claw-type latch bolt moveably mounted on the chassis. The latch bolt has a closed position for retaining a striker and an open position for releasing the striker. The latch bolt is provided with a latch abutment remote from a center of rotation. The latch assembly further includes a pawl having an engaged position for holding the latch bolt in the closed position and a disengaged position that allows the latch bolt to move to the open position. The latch assembly includes an eccentric arrangement defining a first axis and a pawl axis remote from the first axis. The pawl is rotatable about the pawl axis. The latch assembly also includes a reset lever rotatably fixed to the eccentric arrangement for mutual rotation with the eccentric arrangement about the first axis. A biasing lever is configured to transmit a biasing force to the reset lever at a position remote from the first axis and to the latch bolt via the latch abutment. The latch assembly includes a biasing device arranged to apply the biasing force to the biasing lever. The latch assembly is configured such that when the pawl retains the latch bolt in the closed position, the biasing lever applies a force to the reset lever to promote disengagement of the pawl, and such that when the pawl is disengaged, the biasing lever promotes the rotation of the latch bolt into the open position.

According to another aspect of the present invention, a method of operating the latch assembly from a closed position to an open position includes the steps of releasing the eccentric arrangement for rotation about the first axis, rotating the reset lever with the biasing lever to disengage the pawl, and rotating the latch bolt with the biasing lever into the open position once the pawl has retracted to a predetermined extent.

### BRIEF DESCRIPTION OF THE DRAWINGS

The invention will now be described, by way of example only, with reference to the accompanying drawings in which:

FIG. 1 is a view of a backplate side of a latch of certain components of a latch arrangement according to the present invention in a closed position, and with the backplate omitted;

FIG. 1A is a view of the backplate side of the latch of certain components of the latch arrangement in the closed position, with the backplate omitted;

FIG. 1B is a view of the backplate side of the latch with further components in place in the closed position;

FIG. 1C is a view of the backplate side of the latch with further components in place in an opening position, respectively;

FIG. 2 is a view of the backplate side of the latch of certain components of the latch arrangement of FIG. 1 in the closed position with further components in place, and the backplate omitted;

FIG. 3 shows certain components of FIG. 2 in a released but not fully open condition while the latch is being opened; and

FIG. 4 shows the same components as FIGS. 2 and 3 in a fully open position.

### DETAILED DESCRIPTION OF THE PREFERRED EMBODIMENT

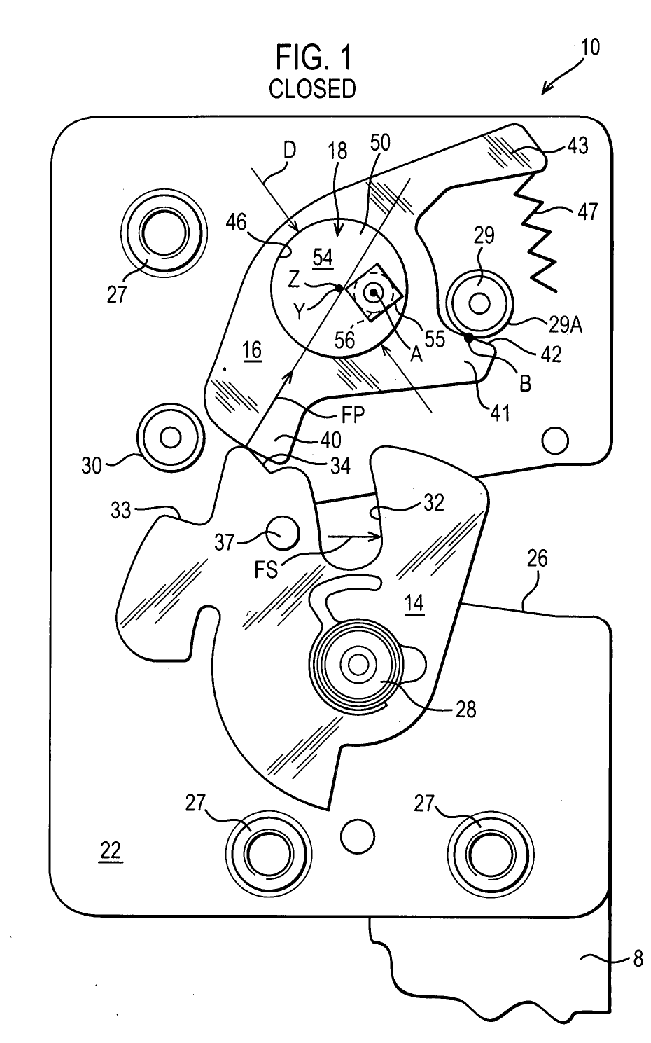

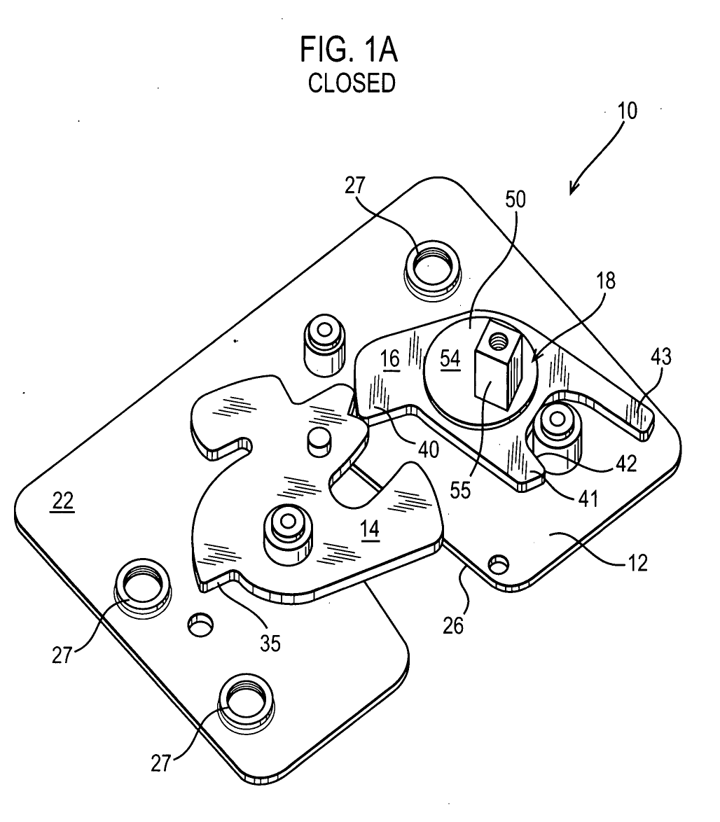

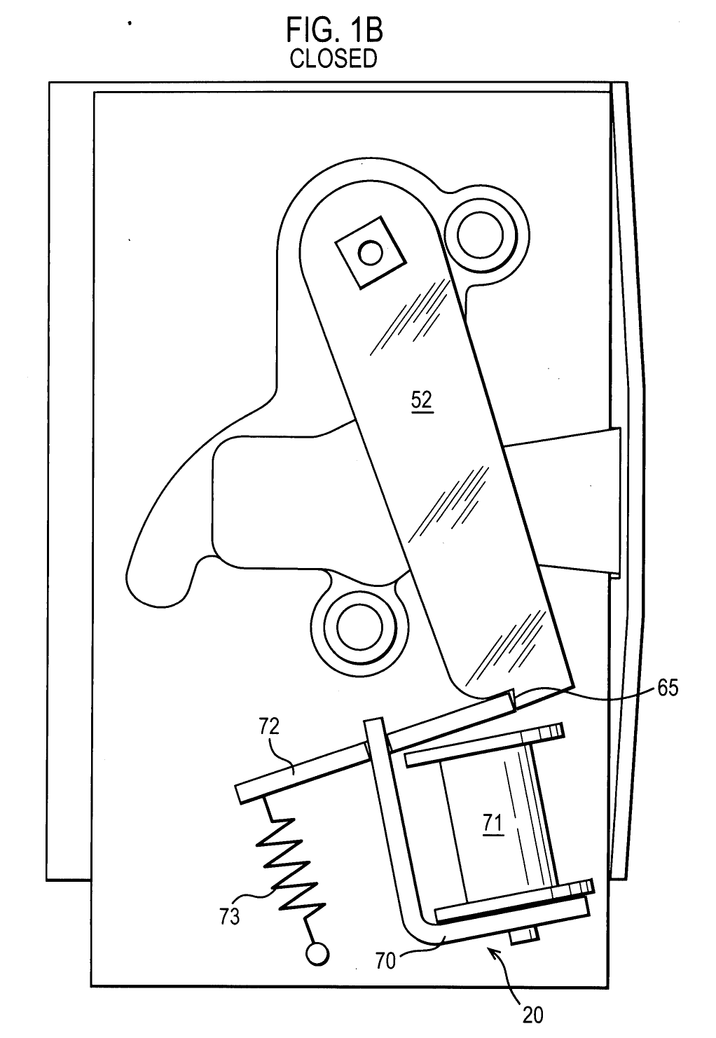

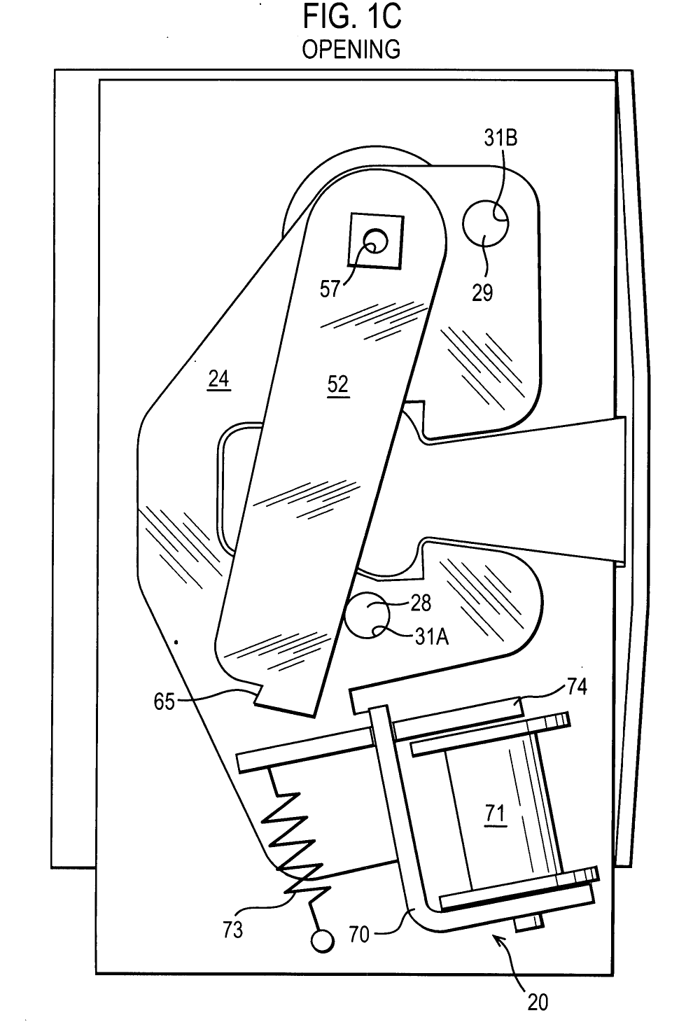

With reference to the Figures, a latch assembly 10 includes a latch chassis 12, a latch bolt in the form of a rotatable claw 14, a pawl 16, an eccentric arrangement in the form of a crank shaft assembly 18 and a release actuator assembly 20. The latch assembly 10 is mounted on a door 8 (only shown in FIG. 1).

The major components of the latch chassis 12 are a retention plate 22 and a backplate 24 (FIG. 1C). The retention plate 22 is generally planar and includes a mouth 26 for receiving a striker (not shown). The retention plate 22 includes three threaded holes 27 whose edges are bent over to project out of the paper as shown in FIG. 1, which in use secure the latch assembly 10 to the door 8. A claw pivot pin 28 and stop pins 29 and 30 protect from the retention plate 22. The stop pin 29 includes a cylindrical outer surface 29A, the purpose of which will be described below.

The backplate 24 (FIG. 1C) includes holes 31A and 31B for receiving ends of the claw pivot pin 28 and the stop pin 29, respectively. During assembly, the ends of the claw pivot pin 28 and the stop pin 29 are peened over to secure the backplate 24 relative to the retention plate 22.

The claw 14 is pivotally mounted on the claw pivot pin 28 and includes a mouth 32 for receiving the striker, a first safety abutment 33 and a closed abutment 34. The claw 14 is generally planar and includes a biasing pin 37 which projects out of the general plane of the claw 14.

The pawl 16 includes a pawl tooth 40, a first arm 41 having an abutment surface 42, and a second arm 43. The pawl 16 also has a pawl pivot hole 46 of an internal diameter D. The pawl 16 is biased in a counter-clockwise direction about a crank pin axis Y (see below) by a spring 47 engaging the second arm 43 when viewing FIG. 1.

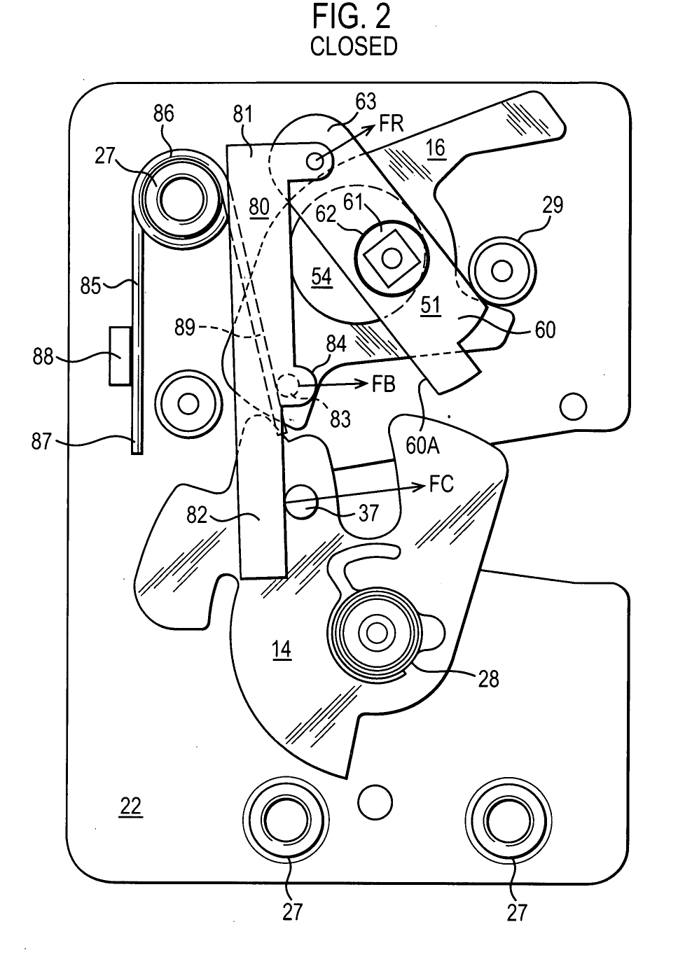

The major components of the crank shaft assembly 18 are a crank shaft 50, a reset lever 51 (FIGS. 2-4) and a release lever 52 (FIGS. 1B and 1C).

The crank shaft 50 includes a crank pin 54 in the form of disc having a crank pin axis Y. A square shaft 55 projects from one side of the crank pin 54, and a cylindrical pin 56 (shown in broken lines in FIG. 1) projects from the other side of the crank pin 54. In other embodiments, alternative forms of the crank shaft 50 may be provided (e.g., other non-circular profiles) to cause components to be rotationally fixed thereto. The square shaft 55 and the cylindrical pin 56 together define a crank shaft axis A. The cylindrical pin 56 is rotatably mounted in a hole (not shown) of the retention plate 22. The retention plate 22 thereby provides a bearing for the cylindrical pin 56. An end of the square shaft 55 is provided with a threaded hole 57.

The diameter of the crank pin 54 is a running fit in the pawl pivot hole 46, i.e., the diameter of the crank pin 54 is slightly less than the internal diameter D. The crank pin axis Y therefore defines a pawl axis about which the pawl 16 can rotate (see below). The thickness of the crank pin 54 is substantially the same as the thickness of the pawl 16.

A reset lever 51 is fitted to the square shaft 55 directly above the crank pin 54 and includes a first arm 60, a second arm 63 and a boss 61 secured intermediate the first arm 60 and the second arm 63. The boss 61 has a cylindrical outer surface 62 and a central hole of square cross section. Accordingly, when the reset lever 51 is assembled onto the square shaft 55, as shown in FIG. 2, the first arm 60 becomes rotationally fixed with the crank shaft 50. The cylindrical outer surface 62 of the boss 61 is mounted in a hole in the backplate 24, which thereby provides a bearing surface for the cylindrical outer surface 62. The cylindrical outer surface 62 and the outer surface of the cylindrical pin 56 are concentric and together define the crank shaft axis A.

A biasing lever 80 is pivotably mounted to the second arm 63 proximate a first end 81 of the biasing lever 80 and extends above the pawl 16 and the claw 14 to contact the biasing pin 37 of the claw 14 proximate a second end 82 of the biasing lever 80. The biasing lever 80 is further provided with a spring abutment 83 intermediate the first end 81 and the second end 82 and a biasing lever nose 84 offset from a plane of the biasing lever 80 to be capable of contacting the reset lever 51.

A biasing device in the form of a torsion spring 85 is secured to the retention plate 22 by the coil portion 86 that encircles one of the threaded holes 27 and a first leg 87 that is retained by a lug 88 of the retention plate 22. A second spring leg 89 contacts the spring abutment 83 to apply a force FB to the biasing lever 80 that acts towards the right as illustrated in FIG. 2. A component of this force is transmitted both to the pivotable connection with the reset lever 51 as a force FR and by the contact between the biasing lever 80 and the biasing pin 37 as a force FC, when the claw 14 is in a closed position.

The 60 includes an edge 60A (also known as a reset abutment) which interacts with the biasing lever nose 84, as will be described further below. The release lever 52 is generally elongate and includes a square hole 64 at one end to receive an end of the square shaft 55 and a release abutment 65 at the other end.

A bolt and washer (not shown) is screwed into the threaded hole 57 of the square shaft 55 to secure the crank shaft 50, the reset lever 51 and the release lever 52 together. Accordingly, the crank shaft 50, the reset lever 51 and the release lever 52 are all rotationally fixed relative to each other.

When assembled, the crank pin 54 and the reset lever 51 are positioned between the retention plate 22 and the backplate 24 with a cylindrical outer surface 62 of the boss 61 being rotationally mounted in a hole (not shown) of the backplate 24. The release lever 52 lies on an opposite side of backplate 24 to the reset lever 51 and the crank pin 54 (best shown in FIG. 1C).

The major components of the release actuator assembly 20 are a bracket 70, an electromagnet 71 and a release plate 72. The bracket 70 is bent from the backplate 24 and is used to mount the electromagnet 71. The bracket 70 is also used to pivotally mount the release plate 72, which is made from a magnetic material, such as steel. The release plate 72 is planar and generally rectangular in plan view and it can be seen from FIG. 1B that it projects equally either side of where it pivots on the bracket 70. Thus, the release plate 72 is balanced.

The release plate 72 is biased in a counter-clockwise direction when viewing FIG. 1B by the spring 73 (shown schematically). The release plate 72 includes an abutment 74 at one end. Other suitable forms of release actuator known in the art may be employed.

Operation of the latch assembly 10 is as follows. Consideration of FIGS. 1, 1A, 1B and 2 show the latch assembly 10 and the associated door 8 in a closed condition. The claw 14 is in a closed position, retaining the striker (not shown). The pawl 16 is in an engaged position whereby the pawl tooth 40 is engaged with the closed abutment 34, thereby holding the claw 14 in the closed position. The weather seals of the door 8 are in a compressed state, and the striker therefore generates a seal force FS on the mouth 32 of claw 14, which tends to rotate the claw 14 in a clockwise direction when viewing FIG. 1.

The seal force FS in turn generates a force FP onto the pawl tooth 40 and hence onto the pawl 16. The force FP is reacted by the crank pin 54 of the crank shaft 50. The force FP reacted by the crank pin 54 is arranged to produce a clockwise torque on the crank shaft 50 about the crank shaft axis A. However, the crank shaft assembly 18 is prevented from rotating clockwise when viewing FIG. 1 by virtue of the engagement between the release abutment 65 of the release lever 52 and the abutment 74 of the release plate 72. The release plate 72 has been biased to the position shown in FIG. 1B by the spring 73. Note that in the closed position, no electric current is flowing through electromagnet 71, which accordingly exerts no magnetic force of the release plate 72.

At the same time, the biasing lever 80 exerts a force FC on the claw 14 via the biasing pin 37 urging it into an open, released condition. A force FR on the reset lever 51 promotes the turning of the crank shaft 50 in a clockwise direction.

To release the latch assembly 10, electric current is supplied to the electromagnet 71, which creates a magnetic force which attracts the right hand end (when viewing FIG. 1B) of the release plate 72, causing the release plate 72 to rotate clockwise to the position shown in FIG. 2A. This in turn allows the release lever 52 and the crank shaft 50 to rotate clockwise (when viewing FIGS. 1 and 2) in an opening direction as a result of the force FP being reacted by the crank pin 54 and of the force FR.

Considering FIG. 1, upon opening, the rotation of the crank shaft 50 is clockwise about the crank shaft axis A. The crank shaft axis A is defined by the cylindrical pin 56 being rotatably mounted in the retention plate 22 (as mentioned above) and the boss 61 being rotatably mounted in the backplate 24 (as mentioned above). Accordingly, the crank shaft axis A is fixed relative to the latch chassis 12.

As mentioned above, when viewing FIGS. 1 and 2, the forces FP and FR generate a clockwise torque upon the crank shaft 50 about the crank shaft axis A. Once the crank shaft 50 is freed to rotate (i.e., once the abutment 74 has disengaged from the release abutment 65), then the crank shaft 50 will move in a clockwise direction because the crank pin axis Y is constrained to move about an arc centred on the crank shaft axis A. Because the pawl pivot hole 46 is a close running fit on the crank pin 54, a pawl axis Z (i.e., the center of the pawl pivot hole 46) is coincident with the crank pin axis Y. Accordingly, the pawl axis Z is similarly constrained to move about an arc centred on crank shaft axis A.

As the crank shaft 50 starts to rotate in a clockwise direction from the position shown in FIG. 1, the claw 14 starts to open. The action of the claw 14 pushing on the pawl 16 and the biasing lever 80 pushing on the reset lever 51 causes the pawl 16 to move. As the pawl 16 moves, the angular position of the pawl 16 is controlled by engagement between the abutment surface 42 of the first arm 41 and the stop pin 29, more particularly a contact point B defined between the abutment surface 42 and part of the cylindrical outer surface 29A.

Generally speaking, the movement of the pawl 16 can be approximated to rotation about the contact point B (i.e., rotation about the contact point between the abutment surface 42 and the cylindrical outer surface 29A). However, the movement is not truly rotational because a part of the pawl 16 (namely the pawl axis Z) is constrained to move about the crank shaft axis A rather than about the contact point B. Thus, the movement of the pawl 16 at the contact point B relative to the stop pin 29 is a combination of rotational movement and transitional (sliding) movement. Indeed, the contact point B is not stationary and will move a relatively small distance around the cylindrical outer surface 29A and a relatively small distance along the abutment surface 42. Thus, the contact point B is the position where (at the relevant time during opening of the latch assembly 10) the abutment surface 42 contacts the cylindrical outer surface 29A.

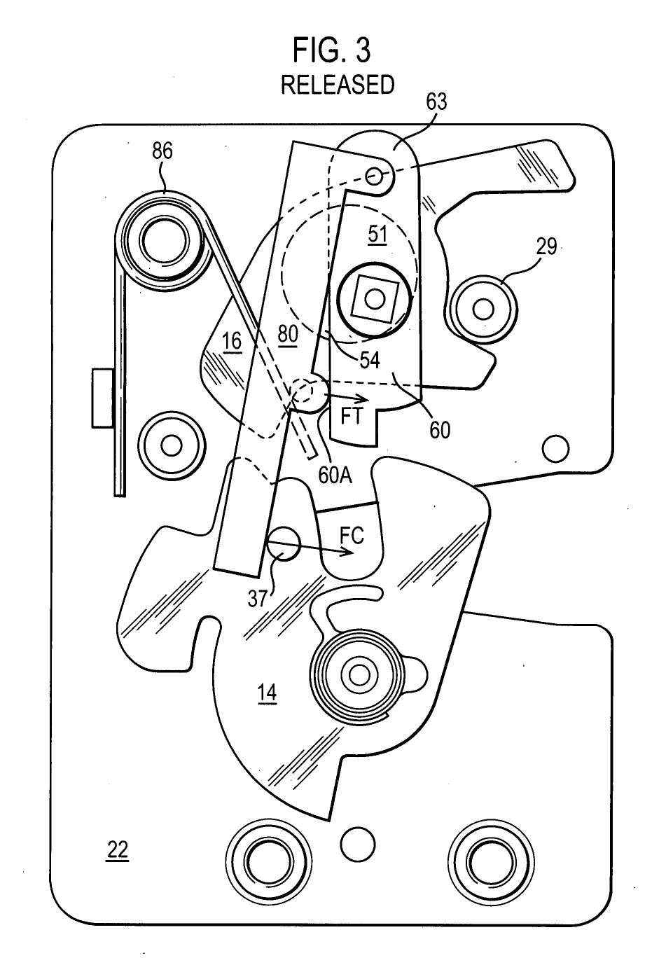

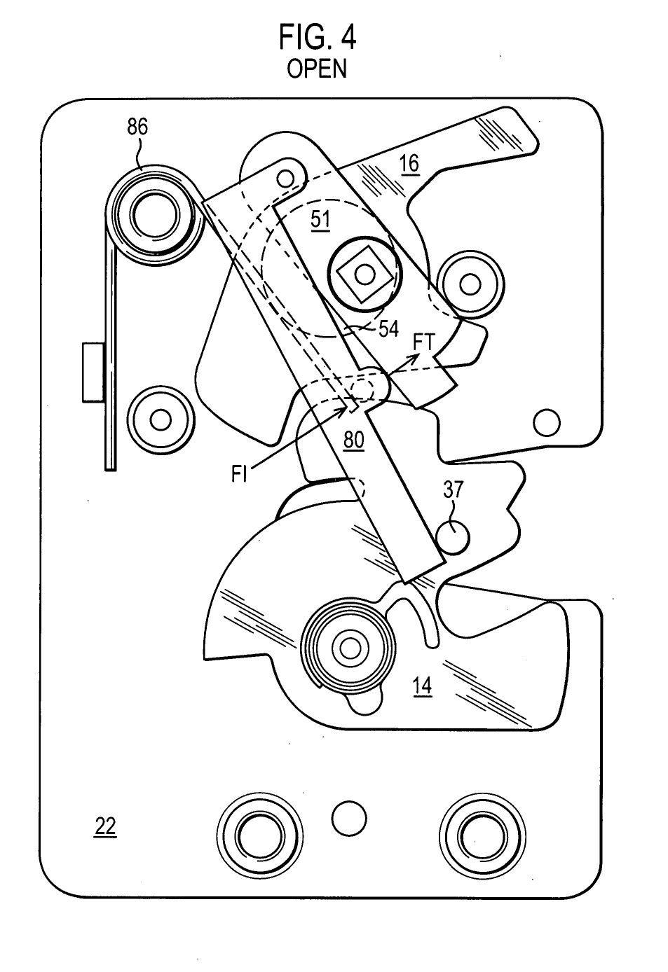

Starting from the FIG. 2 position, once the abutment 74 has disengaged from the release abutment 65, the force FR causes the biasing lever 80 to rotate clockwise about the biasing pin 37 (acting as a fulcrum), and the closed abutment 34 of the claw 14 pushes the pawl 16 (via the pawl tooth) to a position whereby the closed abutment 34 can pass under the pawl tooth 40 when viewing FIG. 3. Once the pawl tooth 40 has thus disengaged from the closed abutment 34 of the claw 14, the claw 14 is then free to rotate past the position shown in FIG. 3 to the fully open position as shown in FIG. 4, urged in this direction by the forces FS and FC.

However, because the biasing pin 37 moves to the right, the biasing lever 80 pivots counter-clockwise about its pivotable connection with the reset lever 51 as it urges the claw 14 into the released position. At a predetermined point before or during this, the biasing lever nose 84 contacts the edge 60A of the reset lever 51. This may be before any rotation of the claw 14 has occurred (with contact occurring by virtue of the rotation of the crank shaft 50 alone) or once a certain amount of the claw 14 rotation has occurred.

As a result of a force FT acting on the edge 60A, the direction in which the biasing lever 80 urges the reset lever 51 reverses so that it is now counter-clockwise about the crank shaft axis A as a fulcrum rather than clockwise. Thus, beyond this predetermined point, the biasing lever 80 acts to reset the crank shaft 50 to the position shown in FIG. 2 where it may re-engage the claw 14 and in which the release lever 52 rotates counter-clockwise back to the position shown in FIG. 1B in which it is retained by the release plate 72. In other words, the crank pin axis Y resets to the FIG. 1 position, and the release lever 52 is returned to the FIG. 1B position.

As the reset lever 51 passes over the right hand end of release plate 72, the release plate 72 is momentarily deflected and then snapped back into engagement (under the influence of the spring 73) such that the abutment 74 re-engages the release abutment 65. Thus, when considering FIG. 4, the pawl 16, the crank shaft assembly 18, and the release actuator assembly 20 are all in the same position as FIGS. 1 to 1B. However, in FIG. 4, the claw 14 is in the open position, whereas in FIGS. 1 to 1B, the claw 14 is in the closed position.

Once the latch assembly 10 and associated door 8 has been opened, closing of the door 8 will automatically relatch the latch assembly 10. Note however, that no rotation of the crank shaft 50 occurs during closing of the door 8. Accordingly, the crank pin axis Y does not rotate, and the crank pin itself acts as a simple pivot having a fixed axis.

As mentioned above, the crank shaft assembly 18 is supported in a bearing of the retention plate 22 on one side of the crank pin 54 and is supported in a bearing in the backplate 24 on the other side of crank pin 54. Thus, the crank shaft 50 is supported on both sides of the crank pin 54, which is a particularly compact and strong arrangement. However, in further embodiments, the crank shaft 50 need only be supported on one side, i.e., the crank shaft 50 can be an overhung crank shaft 50. An example of such an overhung crank shaft 50 would be provided by deleting the cylindrical pin 56. Note that the crank shaft axis A would still be in exactly the same position because it would be defined by the cylindrical outer surface 62.

The arrangement of the present invention permits a single biasing device (spring) to perform the function of promoting release and resetting of a crankshaft mounted pawl, while also urging a claw 14 into an open position.

The crank throw (the distance between the crank shaft axis A and the crank pin axis Y) is dimensioned, in this embodiment, such that no part of the cylindrical pin 56 sits outside the circumference of the crank pin 54. This provides a particularly compact arrangement. In further embodiments, the crank pin axis Y can be offset from the crank shaft axis A by more than the radius of the crank pin 54. In addition, suitable alternative biasing devices may be used in place of the torsion spring. The position at which the spring contacts the biasing lever 80 may be adjusted according to the proportion of the force required to be transmitted to the claw 14 and the reset lever 51. The reset lever 51 could in alternative embodiments be integral with the crank shaft 50. In addition, the reset lever 51 and the release lever 52 may be the same component. Furthermore, in a highly integrated design the crank shaft 50, the reset lever 51 and the release lever 52 could all be a single component.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A latch assembly comprising:
a chassis;
a rotatable claw-type latch bolt moveably mounted on the chassis and having a closed position for retaining a striker and an open position for releasing the striker, wherein the rotatable claw-type latch bolt is provided with a latch abutment remote from a center of rotation;
a pawl having an engaged position for holding the rotatable claw-type latch bolt in the closed position and a disengaged position for allowing the rotatable claw-type latch bolt to move to the open position, wherein the pawl is rotatable about a pawl axis;
an eccentric arrangement defining a first axis and the pawl axis remote from the first axis;
a reset lever rotatably fixed to the eccentric arrangement for mutual rotation with the eccentric arrangement about the first axis;
a biasing lever configured to transmit a biasing force to the reset lever at a position remote from the first axis and to the rotatable claw-type latch bolt via the latch abutment; and
a biasing device arranged to apply the biasing force to the biasing lever, wherein the latch assembly is configured such that when the pawl retains the latch bolt in the closed position, the biasing lever applies a force to the reset lever to promote disengagement of the pawl, and such that when the pawl is disengaged, the biasing lever promotes rotation of the rotatable claw-type latch bolt into the open position.

2. The latch assembly according to claim 1 wherein the biasing lever further includes a biasing lever abutment configured to contact the reset lever at a predetermined stage before or during rotation of the rotatable claw-type latch bolt between the closed position and the open position, thereby reversing a direction of rotation of the reset lever and resetting the pawl to a position in which the pawl may re-engage the rotatable claw-type latch bolt.

3. The latch assembly according to claim 1 wherein the latch assembly is configured such that the rotatable claw-type latch bolt abutment acts as a fulcrum during motion of the reset lever to release the pawl.

4. The latch assembly according to claim 2 wherein the latch assembly is configured such that the first axis acts as a fulcrum once the biasing lever abutment contacts the reset lever to reverse the direction of rotation.

5. The latch assembly according to claim 1 wherein the biasing lever includes a first end and a second end, and the biasing force is applied to the biasing lever intermediate the first end and the second end.

6. The latch assembly according to claim 1 wherein the biasing lever includes a first end, and the biasing lever contacts the reset lever proximate the first end.

7. The latch assembly according to claim 1 wherein the biasing lever is pivotably connected to the reset lever.

8. The latch assembly according to claim 1 wherein the biasing lever includes a second end, and the biasing lever contacts the latch bolt abutment proximate the second end.

9. The latch assembly according to claim 1 wherein the latch assembly is configured such that during movement of the pawl from the engaged position to the disengaged position, the eccentric arrangement rotates in an opening direction such that the pawl axis is constrained to move along an arc centred on the first axis.

10. The latch assembly according to claim 9 wherein the chassis includes a chassis control surface and the pawl includes a pawl control surface, and the chassis control surface is engageable by the pawl control surface during movement of the pawl from the engaged position to the disengaged position to control an angular position of the pawl with respect to the chassis.

11. The latch assembly according to claim 1 wherein the eccentric arrangement comprises a crank shaft.

12. The latch assembly according to claim 11 wherein the crank_shaft is rotatably mounted on the chassis about the first axis, the crank shaft includes a crank pin, and the pawl is rotably mounted on the crank pin to be rotatable about the pawl axis.

13. The latch assembly according to claim 11 wherein the reset lever is integral with the crank_shaft.

14. The latch assembly according to claim 1 further including a release lever rotationally fixed to the eccentric arrangement for mutual rotation about the first axis.

15. The latch assembly according to claim 14 wherein the reset lever is integral with the release lever.

16. The latch assembly according to claim 14 further including a release actuator.

17. A method of operating a latch assembly from a closed position to an open position, the latch assembly including:
a chassis,
a rotatable claw-type latch bolt moveably mounted on the chassis and having a closed position for retaining a striker and an open position for releasing the striker, wherein the rotatable claw-type latch bolt is provided with a latch abutment remote from a center of rotation,
a pawl having an engaged position for holding the rotatable claw-type latch bolt in the closed position and a disengaged position for allowing the rotatable claw-type latch bolt to move to the open position, wherein the pawl is rotatable about a pawl axis,
an eccentric arrangement defining a first axis and the pawl axis remote from the first axis;
a reset lever rotatable fixed to the eccentric arrangement for mutual rotation with the eccentric arrangement about the first axis,
a biasing lever configured to transmit a biasing force to the reset lever at a position remote from the first axis and to the rotatable claw-type latch bolt via the latch abutment, and
a biasing device arranged to apply the biasing force to the biasing lever, wherein the latch assembly is configured such that when the pawl retains the rotatable claw-type latch bolt in the closed position, the biasing lever applies a force to the reset lever to promote disengagement of the pawl, and such that when the pawl is disengaged, the biasing lever promotes rotation of the rotatable claw-type latch bolt into the open position, the method comprising the steps of:
releasing the eccentric arrangement for rotation about the first axis;
using the biasing lever to rotate the reset lever to disengage the pawl; and
using the biasing lever to rotate the rotatable claw-type latch bolt into the open position once the pawl has retracted a predetermined extent.

18. The method of claim 17 further comprising the step of using the biasing lever to reverse a direction of rotation of the reset lever, thereby resetting the pawl to a position in which the pawl may re-engage the rotatable claw-type latch bolt at a predetermined position of the rotatable claw-type latch bolt between the closed position and the open position.

19. The method of claim 16 wherein the release actuator is an electrically operable release actuator.
